(19) United States
(12) Patent Application Publication
(10) Pub. No.: US 2021/0060716 A1
(43) Pub. Date: Mar. 4, 2021

(54) PRESSURED WELDING HABITAT

(71) Applicant: NEPTUNE SUBSEA ENGINEERING PTY LTD, WELSHPOOL (AU)

(72) Inventor: STEPHEN JAMES FITZSIMMONS, WELSHPOOL (AU)

(73) Assignee: NEPTUNE SUBSEA ENGINEERING PTY LTD., WELSHPOOL (AU)

(21) Appl. No.: 16/644,384

(22) PCT Filed: Sep. 3, 2018
(86) PCT No.: PCT/AU2018/000164

§ 371 Date: Mar. 4, 2020

(30) Foreign Application Priority Data
Sep. 4, 2017 (AU) 2017903573

(51) Int. Cl. B23K 37/02

(52) U.S. Cl. CPC B23K 37/0235; B23K 9/0061; B23K 37/0241

(57) ABSTRACT

A pressurised welding habitat comprising; a housing configured to provide a sealed chamber, a port configured to connect to a gas supply and enable pressurisation of the chamber, and a sealing unit comprising a channel, wherein the channel is moveable relative to the housing and is configured to provide sealed instrument access to the chamber.

### FIELD OF THE INVENTION

The present invention relates to a Pressurised Welding Habitat.

More particularly, the present invention relates to a Pressurised Welding Habitat to enable qualification of underwater welds, where the qualification takes place at a shallower depth than the field weld.

### BACKGROUND

Underwater welding is often used to carry out repairs on underwater structures.

One method of carrying out an underwater weld is to use a device for isolating a surface for welding, in accordance with Australian Patent Number 2001254515, in the name of the present applicants.

The device in accordance with the above mentioned patent provides a chamber, sealed against the surface(s) of the components to be welded, and comprising a sealed inlet for welding apparatus.

Gas is pumped in to the chamber, displacing the water, and thereby providing a dry environment suitable for welding.

To prepare for a successful class weld, a qualification weld must be performed.

To qualify a weld, the underwater conditions must be sufficiently replicated to ensure that a weld under such conditions will have the desired properties.

The conditions which must be replicated are known as the essential variables.

Replicating the essential variables to qualify a weld can be difficult and expensive, especially when qualifying a weld to be carried out at significant depth, due to the requirement to replicate the high pressure environment for qualification.

When a weld is performed in a high pressure environment, the carbon and oxygen levels within the weld can increase as the pressure increases. Alloying elements such as magnesium, silicon and nickel are burnt off in greater quantities, and are therefore less present in welds performed at greater pressure. Consequently, the chemical composition and material properties of a weld are different when the weld is performed under pressure.

Industry standards are used to determine the conditions under which a weld may be qualified. For example, American welding society underwater welding code standard D3.6M states that the depth at which the weld is qualified can be up to 20 metres shallower than the field weld.

Using this standard, a weld that is qualified at a facility in a tank at 5 m depth, may be then performed at up to 25 m deep, providing all other essential variables are also replicated satisfactorily.

Consequently, the depth at which a field weld may be undertaken is limited by the depth at which it can be qualified.

To qualify welds at significant depth, 100 m for example, is not feasible in a facility without the use of a hyperbaric chamber or similar apparatus, which is very costly and only allows a limited amount of time.

Hyperbaric chambers suitable for weld qualification requiring personnel are rare and expensive. They are typically privately owned and time slots are leased, which are normally booked well in advance. Consequently, qualification of a weld at depth can be a very expensive exercise, and can cause significant schedule impact when the time slot is either unavailable for some time, or is cancelled due to circumstances beyond the control of the client.

The present invention attempts to overcome at least in part the aforementioned disadvantages of previous weld qualification systems by providing a Pressurised Welding Habitat capable of qualification of underwater welds at a shallower depth than the required weld.

### SUMMARY OF THE INVENTION

In accordance with one aspect of the present invention there is provided a pressurised welding habitat comprising; a housing configured to provide a sealed chamber, a port configured to connect to a gas supply and enable pressurisation of the chamber, and a sealing unit comprising a channel, wherein the channel is moveable relative to the housing and is configured to provide sealed instrument access to the chamber.

Preferably, the sealing unit comprises a body portion located in a wall of the housing, and a moveable portion configured to sealingly engage with, and move relative to, the body portion, wherein the moveable portion comprises a channel configured to provide instrument access to the chamber.

Preferably, the moveable portion comprises a spherical portion configured to sealingly engage with a corresponding spherical recess in the body portion, so that the moveable portion is able to move around a centre of the spherical portion relative to the housing.

The housing preferably further comprises a window, to enable an operator to view the weld during the weld operation.

The sealing unit may be attached to the window.

Alternatively, the sealing unit may be attached to a wall of the housing.

The habitat preferably further comprises an attachment, configured to sealingly connect to the sealing unit and to a welding apparatus, wherein the attachment is configured to enable movement of the welding apparatus relative to the sealing unit.

Preferably, the movement of the welding apparatus relative to the sealing unit is telescopic.

Preferably, the attachment comprises a pressure balancing mechanism, to counteract the pressure within the housing.

Preferably, the telescopic attachment comprises at least a proximal section and a distal section, wherein the distal section is configured to sealingly connect to the sealing unit, and wherein the proximal section is configured to sealingly connect to the welding apparatus, and wherein the proximal section comprises a port to insert gas, so that pressure within the housing may be balanced by the insertion of gas into the proximal section, so that an operator may advance the welding apparatus to progress with a weld.

In accordance with an embodiment of the present invention, there is provided a method of conducting pressurised weld qualification comprising the following steps:
a. locating a weld test piece within a pressurised welding habitat; the pressurised welding habitat comprising,
   a housing configured to provide a sealed chamber,
   a port configured to connect to a gas supply and enable pressurisation of the chamber, and
   a sealing unit comprising a channel, wherein the channel is moveable relative to the housing and is configured to provide sealed access to the chamber,
b. inserting a welding apparatus into the chamber through the channel,
c. pressurising the housing to a desired level by connecting a gas supply to the port,
d. advancing the welding apparatus through the channel, and moving the apparatus relative to the housing, to enable a weld of desired proportions to be performed upon the weld test piece.

Preferably, the method further comprises the following steps after step a.:
i. affixing an attachment to the sealing unit; wherein the attachment is configured to sealingly connect to the sealing unit and to a welding apparatus, and wherein the attachment is further configured to enable telescopic movement of the welding apparatus relative to the sealing unit.
ii. inserting the weld apparatus into the attachment, and advancing the weld apparatus toward the sealing unit,

### BRIEF DESCRIPTION OF DRAWINGS

The present invention will now be described, by way of example, with reference to the accompanying drawings, in which:

FIG. 1 is an isometric view of an embodiment of the habitat.

FIG. 2 is an isometric section view of an embodiment of the habitat, showing a weld test piece inside the habitat.

FIG. 3 is an isometric view showing an embodiment of the sealing unit.

FIG. 4 is an exploded isometric view of an embodiment of the sealing unit.

FIG. 5 is an isometric view of an embodiment of the welding apparatus connected to the attachment.

FIG. 6 is an isometric section view of an embodiment of the welding apparatus connected to the attachment.

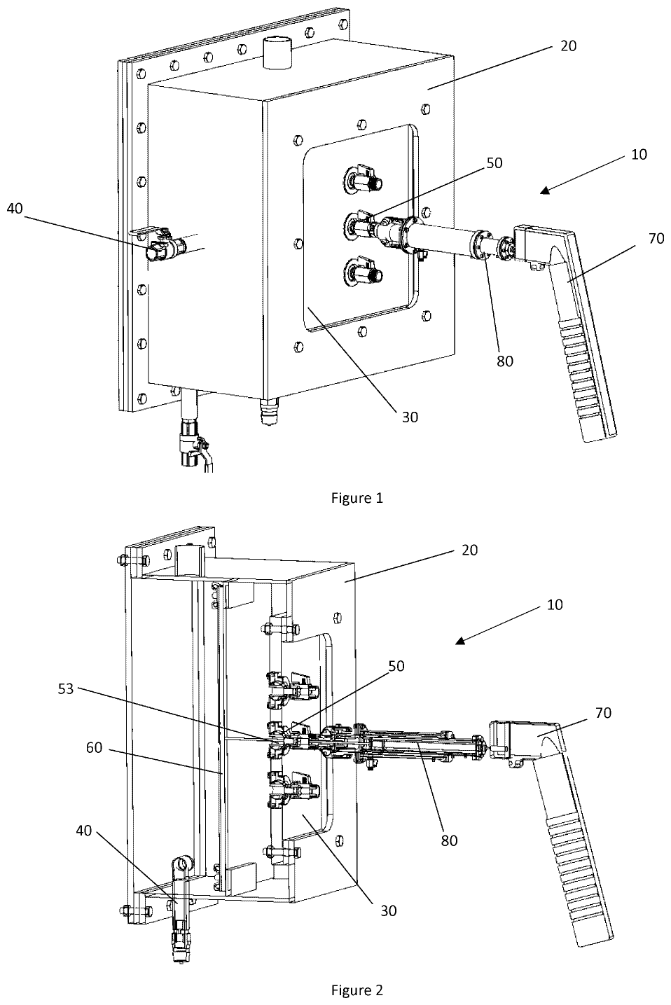

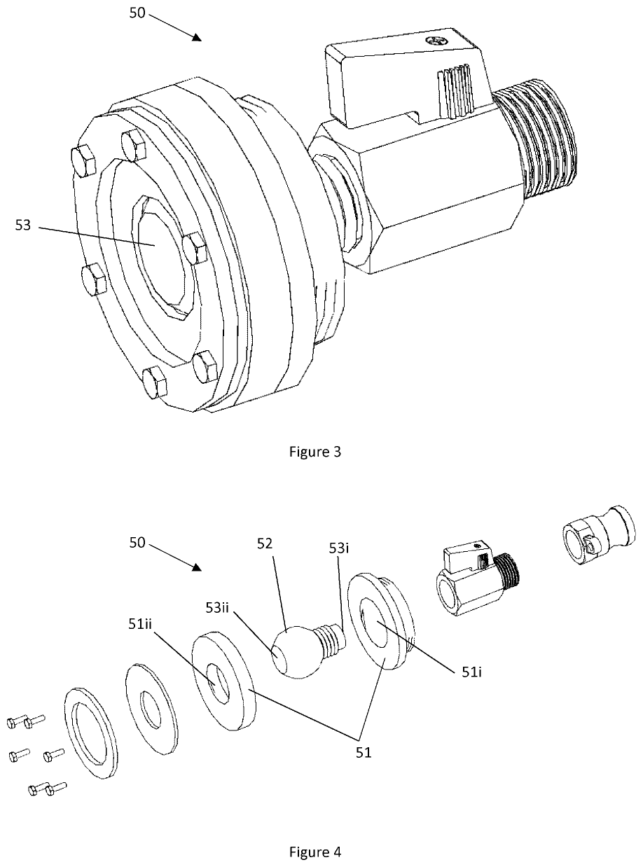

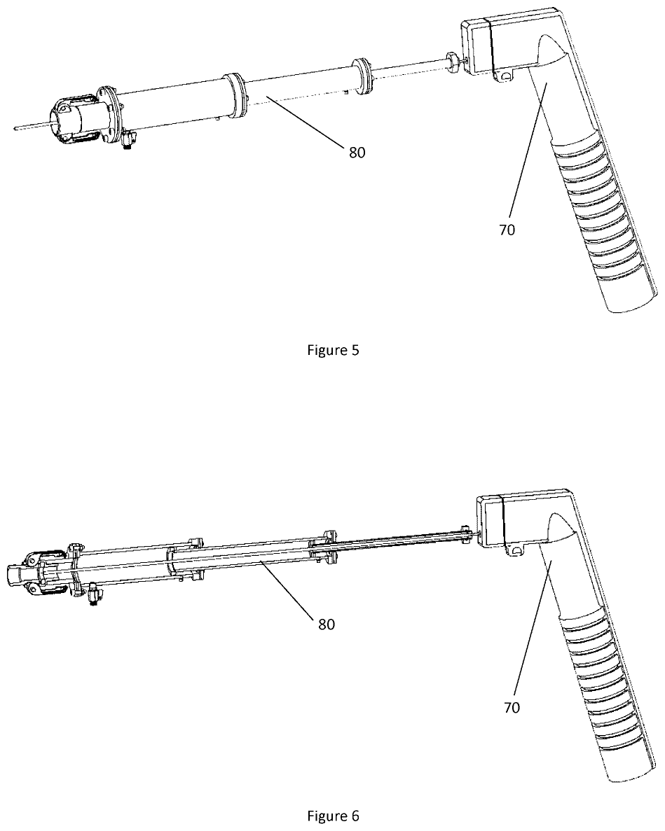

### DESCRIPTION OF PREFERRED EMBODIMENTS

Referring to the Figures, there is shown a Pressurised Welding Habitat in accordance with a preferred embodiment of the present invention.

In accordance with one aspect of the present invention there is provided a pressurised welding habitat 10 comprising; a housing 20 configured to provide a sealed chamber, a port 40 configured to connect to a gas supply and enable pressurisation of the chamber, and a sealing unit 50 comprising a channel 53, wherein the channel 53 is moveable relative to the housing 20 and is configured to provide sealed instrument access to the chamber.

In the preferred embodiment of the present invention, the housing 20 comprises a window 30.

The sealing unit 50 may be located in the window 30 of the housing 20.

The sealing unit 50 may alternatively be located in a wall of the housing 20.

The sealing unit 50 may be affixed to the housing 20 using a screw thread and a flange.

According to one aspect of the present invention, which may be particularly suited to lower pressure environments, the sealing unit 50 may comprise a pliable sock, wherein the sock comprises the instrument channel 53, and wherein the instrument channel 53 comprises an aperture configured to seal against the instrument 70.

According to another aspect of the present invention, the sealing unit 50 comprises a body portion 51 located in a wall of the housing 20, and a moveable portion 52 configured to sealingly engage with, and move relative to, the body portion 51, wherein the moveable portion 52 comprises the channel 53.

The body portion 51 may have a recess, an external aperture 51i, and an internal aperture 51ii.

The body portion 51 may be configured to receive a moveable portion 52, the moveable portion 52 having a channel 53 running therethrough, from an opening 53i located at the exterior of the housing 20 to an opening 53ii located at the interior of the housing 20.

The moveable portion 52 may be spherical, and is described as such henceforth, but it is recognised that alternative shapes may be used, for example a cylindrical form may provide adequate functionality under certain circumstances.

The moveable portion 52 may sealingly engage with the body portion 51, so that the moveable portion 52 may be moved relative to the body 51, while maintaining a seal between the two.

The openings 53i and 53iiof the channel may be coincident with the apertures 51i and 51ii in a nominal position.

The external aperture 51i and the internal aperture 5 lii may be sufficiently large that the openings 53i and 53ii of the channel 53 remain unobscured by the apertures 51i and 51ii when the moveable portion 52 is moved to its extremities.

The perimeter defined by the apertures 51i and 51ii may therefore define the limit of movement of the moveable portion 52 at which the channel 53 may provide instrument access from the exterior of the housing 20 to the interior.

The channel 53 may be configured to receive welding apparatus 70.

The welding apparatus 70 may comprises a welding rod which is mechanically advanced through the channel 53 whilst under pressure.

Alternatively, the welding apparatus 70 may comprise a welding rod which may be advanced manually by the welder during the welding process.

According to one aspect of the present invention, an attachment 80 may be configured to sealingly engage with both the moveable portion 52 of the sealing unit 50, and the welding apparatus 70.

In embodiments where the sealing unit 50 is a pliable sock, the attachment 80 may be configured to sealingly engage with an end of the sealing unit 50, and the welding apparatus 70.

The attachment 80 may be capable of telescopic movement to advance the welding apparatus 70.

The attachment 80 may comprise telescopic sections, each sealingly slidable against an adjacent section, to provide a range of telescopic movement between the opposed ends of the attachment 80. In use, the attachment 80 is affixed to the sealing unit 50, and a welding apparatus 70 is inserted into the attachment 80 and sealed against an opposed end of the attachment 80.

The movement of the channel 53 relative to the chamber, enabled by the sealing unit 50, and the telescopic movement of the welding apparatus 70 relative to the sealing unit 50, allows an operator to advance and manipulate a tip of the welding apparatus 70, to achieve a weld of desired proportions.

The attachment 80 may comprise a mechanism to balance the pressure across the sections of the telescope, thus enabling reduced resistance when the welding apparatus is urged toward the housing 20, and providing greater ease of use.

The pressure balance may be achieved by providing a channel connecting opposite end portions of each section, so that pressurised gas is able to pass between the sections while maintaining overall pressure within the attachment 80.

The pressure balance may be achieved by insertion of gas into the section of the telescope furthest from the housing 20, so that increase pressure within the housing 20 is balanced by the increased pressure in the section of the telescope. This allows the operator to manipulate the welding apparatus 70 in the housing 20, without the adverse impact of bias due to the pressure.

The habitat 10 may further comprise means to expel water which may have entered the chamber undesirably.

The habitat 10 may comprise a valve, so that pressure within the housing can be maintained when the welding apparatus 70 is disconnected.

The valve may be a ball valve.

The housing 20 may comprise additional ports, to enable access for other instrumentation, for example temperature measurement instruments.

The housing may further comprise additional sealing units 50, to enable multiple qualification welds to be performed without opening the housing, or to enables a weld of greater length to be performed than would be possible with a single sealing unit 50.

In use, a weld test piece 60 may be located inside the housing 20.

The weld test piece 60 may be fixed into position to prevent movement relative to the housing 20.

The welding apparatus 70 may be sealingly connected to the sealing unit 50.

Alternatively, the welding apparatus 70 may be connected to the attachment 80, which is in turn connected to the sealing unit 50.

If present, the valve may be opened, thus allowing the pressure environment of the housing to be extended to the welding apparatus 70.

A gas supply may be connected to the port 40, and the chamber may be pressurised to a desired level.

The desired pressure may correspond to approximately the depth at which the weld is to be qualified.

Alternatively, the desired pressure may correspond to within 20 m of the depth at which the weld is to be qualified.

Alternatively, the desired pressure may correspond to within a desired range of depths suitable for qualification.

The welding apparatus 70 may be advanced through the attachment 80, and into the chamber.

Alternatively, the welding apparatus 70 may be advanced through the channel 53, and into the chamber.

The tip of the welding apparatus 70 may be manipulated within the chamber by adjusting the moveable portion 52 relative to the housing 20, and by adjusting the protrusion of the welding apparatus 70 through the channel 53.

The moveable portion 52 provides angular movement relative to the housing, and the channel 53 provides movement along the axis of the welding apparatus 70.

The operator may proceed with a weld by manipulating the welding apparatus 70 as described, and viewing the progress of the weld through the window 30.

Once the qualification weld is complete, the pressure within the chamber may be reduced to substantially similar to ambient pressure.

The housing 20 may then be opened so that the weld can be examined.

The preceding method allows for a qualification weld to be performed in a high pressure environment, thus enabling welds required at significant underwater depth to be qualified by the use of the habitat 10, and without the need for a hyperbaric chamber or diving to such depths.

Modifications and variations as would be apparent to a skilled addressee are deemed to be within the scope of the present invention.

In the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1-13. (canceled)

14. A pressurised welding habitat comprising:
a housing configured to provide a sealed chamber;
a port configured to connect to a gas supply and enable differential pressure to be applied to the chamber; and a sealing unit comprising;
a body portion located in a wall of the housing; and
a moveable portion configured to sealingly engage with, and move relative to, the body portion;
wherein the moveable portion comprises a spherical portion configured to sealingly engage with a corresponding recess in the body portion, so that the moveable portion is able to move around a centre of the spherical portion relative to the housing, wherein the moveable portion comprises a channel configured to provide instrument access to the chamber, and wherein the sealing unit is configured to seal against the instrument.

15. A pressurised welding habitat according to claim 14, wherein the housing comprises a window, to enable an operator to view the weld during the weld operation.

16. A pressurised welding habitat according to claim 14, wherein the sealing unit is attached to the window.

17. A pressurised welding habitat according to claim 14, wherein the sealing unit is attached to the wall of the housing.

18. A pressurised welding habitat according to claim 14, wherein the habitat further comprises:
an attachment, configured to sealingly connect to the sealing unit and to a welding apparatus;
wherein the attachment is configured to enable movement of the welding apparatus relative to the sealing unit.

19. A pressurised welding habitat according to claim 18, wherein the movement enabled by the attachment is telescopic.

20. A pressurised welding habitat according to claim 18, wherein the attachment comprises a pressure balancing mechanism.

21. A pressurised welding habitat according to claim 19, wherein the telescopic attachment comprises at least a proximal section and a distal section, wherein the distal section is configured to sealingly connect to the sealing unit, and wherein the proximal section is configured to sealingly connect to the welding apparatus, and wherein the proximal section comprises a port to insert gas, so that pressure within the housing may be balanced by the insertion of gas into the proximal section, so that an operator may advance the welding apparatus to progress with a weld.

22. A method of conducting pressurised weld qualification comprising the following steps:
a. locating a weld test piece within a pressurised welding habitat; the pressurised welding habitat comprising,
a housing configured to provide a sealed chamber,
a port configured to connect to a gas supply and enable differential pressure to be applied to the chamber, and
a sealing unit comprising;
a body portion located in a wall of the housing; and
a moveable portion configured to sealingly engage with, and move relative to, the body portion;
wherein the moveable portion comprises a spherical portion configured to sealingly engage with a corresponding recess in the body portion, so that the moveable portion is able to move around a centre of the spherical portion relative to the housing, and wherein the moveable portion comprises a channel configured to provide instrument access to the chamber;
b. inserting a welding apparatus into the chamber through the channel,
c. applying a differential pressure to the housing to a desired level by connecting a gas supply to the port,
d. advancing the welding apparatus through the channel, and moving the apparatus relative to the housing, to enable a weld of desired proportions to be performed upon the weld test piece.

23. A method of conducting pressurised weld qualification according to claim 22, further comprising the following steps after step a.:
i. affixing an attachment to the sealing unit;
wherein the attachment is configured to sealingly connect to the sealing unit and to a welding apparatus, and wherein the attachment is further configured to enable telescopic movement of the welding apparatus relative to the sealing unit.
ii. inserting the weld apparatus into the attachment, and advancing the weld apparatus toward the sealing unit.

24. A pressurised welding habitat according to claim 14, wherein the differential pressure is greater than 300 KPa.

25. A pressurised welding habitat according to claim 14, wherein the differential pressure is greater than that experienced at 20 m depth in a subsea environment.

26. A method of conducting pressurised weld qualification according to claim 14, wherein, at step c. the differential pressure is greater than 300 KPa.
